(19) United States
(12) Patent Application Publication
(10) Pub. No.: US 2025/0131064 A1
(43) Pub. Date: Apr. 24, 2025

(54) ENHANCING AMI EVENT CLASSIFICATION WITH GRAPH NEURAL NETWORKS (GNNs)

(71) Applicant: NEC Laboratories America, Inc., Princeton, NJ (US)

(72) Inventors: Yangmin DING, East Brunswick, NJ (US); Yanchao WANG, Princeton, NJ (US); Ting WANG, West Windsor, NJ (US)

(73) Assignee: NEC Laboratories America, Inc., Princeton, NJ (US)

(21) Appl. No.: 18/901,647

(22) Filed: Sep. 30, 2024

Related U.S. Application Data
(60) Provisional application No. 63/591,147, filed on Oct. 18, 2023.

(51) Int. Cl. G06F 18/241; G06Q 10/0639

(52) U.S. Cl. CPC G06F 18/241; G06Q 10/0639

(57) ABSTRACT

Disclosed are systems, methods, and structures that enhance advanced metering infrastructure (AMI) event classification with graph neural networks (GNNs) in which AMI data is represented as a graph, where each meter is a node and connections between nodes represent the physical or functional relationship between meters. As a result, our systems and methods capture dependency information between different meters and use this information to predict events and anomalies.

### CROSS-REFERENCE TO RELATED APPLICATIONS

This application claims the benefit of U.S. Provisional Patent Application Ser. No. 63/591,147 filed Oct. 18, 2023 the entire contents of which is incorporated by reference as if set forth at length herein.

### FIELD OF THE INVENTION

This application relates generally to energy measurement using neural networks. More particularly, it pertains to systems and methods that enhance advanced metering infrastructure (AMI) event classification with graph neural networks (GNNs).

### BACKGROUND OF THE INVENTION

AMI (Advanced Metering Infrastructure) data is known as a valuable resource for neural networks, particularly in the fields of energy management, demand response, and predictive maintenance, and may provide detailed information about electricity consumption patterns.

Existing methods for event classification in AMI data typically rely on supervised learning algorithms such as decision trees, support vector machines, and deep neural networks. While these methods have shown promise in detecting anomalies and classifying events, they often suffer from limitations in accuracy and efficiency when applied to AMI data.

### SUMMARY OF THE INVENTION

An advance in the art is made according to aspects of the present disclosure directed to systems and methods that enhance advanced metering infrastructure (AMI) event classification with graph neural networks (GNNs).

In sharp contrast to the prior art, systems and methods according to aspects of the present disclosure represent AMI data as a graph, where each meter is a node and connections between nodes represent the physical or functional relationship between meters. As a result, our inventive systems and methods capture dependency information between different meters and use this information to predict events and anomalies.

Subsequently, GNNs are then used to learn complex relationships between meters and identify patterns and correlations that may not be evident from examination of individual meters in isolation.

Viewed from a first aspect, systems and methods according to aspects of the present disclosure provide new and innovative methods for event classification in Advanced Metering Infrastructure (AMI) data using Graph Neural Networks (GNNs). AMI systems provide utilities and energy providers with vast amounts of data on energy usage patterns across the grid, but accurately classifying events in this data can be a challenging and time-consuming task. Existing methods for event classification in AMI data are limited by their inability to capture the complex dependencies between different devices, meters, and energy consumption patterns.

Viewed from another aspect, systems and methods according to the present disclosure provide solutions to the problems associated with existing methods, our solutions lie in the use of GNNs, a type of deep learning algorithm specifically designed to operate on data represented as graphs. In the context of AMI data, each meter or device is represented as a node in the graph, and the connections between nodes represent the relationships and interactions between different devices, meters, and energy consumption patterns. Advantageously, our GNNs can analyze this graph and classify events based on the patterns and features learned from the data.

Viewed from yet another aspect, our inventive approach to event classification in AMI data using Graph Neural Networks is based on several features that significantly differentiate it from existing methods: First, our approach uses a graph representation of the AMI data, which captures the dependencies between different devices and meters, allowing for more accurate and efficient event classification. This graph representation enables the GNN to effectively capture the complex relationships and dependencies between different devices and meters, which are often missed by traditional methods.

Furthermore, our approach uses a semi-supervised learning framework, which allows for more efficient and accurate event classification. By leveraging both labeled and unlabeled data, a GNN can learn from a larger pool of data, improving its ability to generalize new, unseen events.

Still further, our approach uses a novel feature selection method that identifies the most informative features for event classification. This reduces the dimensionality of the input data and improves the efficiency and accuracy of the GNN.

Finally, our inventive approach is adaptable to different types of events and can be customized to specific use cases, making it a versatile and flexible tool for event classification in AMI data.

### BRIEF DESCRIPTION OF THE DRAWING

FIG. 1 is a schematic diagrams showing an illustrative GNN based AMI event classification arrangement according to aspects of the present disclosure;

FIG. 2 is a schematic flow diagram showing illustrative features of GNN based AMI event classification systems and methods according to aspects of the present disclosure;

FIG. 3 is a schematic block diagram showing an illustrative semi-supervised framework of a GNN based AMI event classification according to aspects of the present disclosure; and

FIG. 4 is a schematic diagram showing an illustrative graph neural network identifier components according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note once again that existing methods for event classification in AMI data typically rely on supervised learning algorithms such as decision trees, support vector machines, and deep neural networks. While these methods have shown promise in detecting anomalies and classifying events, they often suffer from limitations in accuracy and efficiency when applied to AMI data.

One major limitation of these existing methods is that they may not be able to capture complex dependencies that may exist between different meters and energy consumption patterns.

As those skilled in the art will understand and appreciate, the energy consumption patterns of different meters can be dependent on each other due to various factors. For example, if there is a malfunctioning device in a building, it can affect the energy consumption patterns of other devices in the same building. Similarly, if there is a change in energy pricing or a demand response event, it can affect the energy consumption patterns of all devices and meters in a network. In addition, the energy consumption patterns of meters in different buildings can be interdependent, particularly if they are connected to the same power distribution network. For example, if there is a fault in the distribution network, it can affect the energy consumption patterns of meters in multiple buildings.

Furthermore, the energy consumption patterns of different buildings can be correlated due to various factors, such as weather patterns, occupancy patterns, or building characteristics. For example, if there is a heat wave, the energy consumption patterns of air conditioning units in multiple buildings can be similar. Likewise, if there is a change in the occupancy patterns of a particular area, it can affect the energy consumption patterns of multiple buildings in that area.

By representing the AMI data as a graph, where each meter is a node and the connections between them represent the physical or functional relationships between meters, our inventive systems and methods according to aspects of the present disclosure capture the dependencies between different meters and use this information to predict events and anomalies. GNNs can then be used to learn the complex relationships between meters and identify patterns and correlations that may not be evident from looking at individual meters in isolation.

Furthermore, yet another limitation of existing methods is their requirement for labeled training data. Those skilled in the art will understand and appreciate that labeled data is data that has been manually annotated with a correct classification or an event type. Such manual annotation is a time-consuming and expensive operation. Additionally, the labeled data may not always be representative of the entire range of possible events, leading to inaccuracies in a trained model's performance.

As we shall show and describe our inventive systems and methods according to the present disclosure advantageously employ GNNs for event classification in AMI data and cure these noted infirmities. Since our GNNs are specifically designed to capture the complex dependencies between different nodes in a graph, they are well-suited for modeling the interconnections between meters, devices, and energy consumption patterns in AMI data.

As those skilled in the art will understand, our GNNs operate by aggregating information from neighboring nodes, allowing them to capture the context and relationships between different nodes in the graph.

Moreover, GNNs can operate on both labeled and unlabeled data. In the case of unlabeled data, GNNs can learn to identify patterns and features within the data without the need for manual annotation. This makes GNNs much more efficient in training and more adaptable to new and emerging types of events.

As a result, our inventive systems and methods that employ GNNs for event classification in AMI data offers several advantages over existing methods, including better accuracy in detecting anomalies and classifying events, greater efficiency in training, and the ability to learn from unlabeled data. These advantages lead to more effective management of energy consumption in buildings and across the grid, ultimately contributing to a more sustainable energy future.

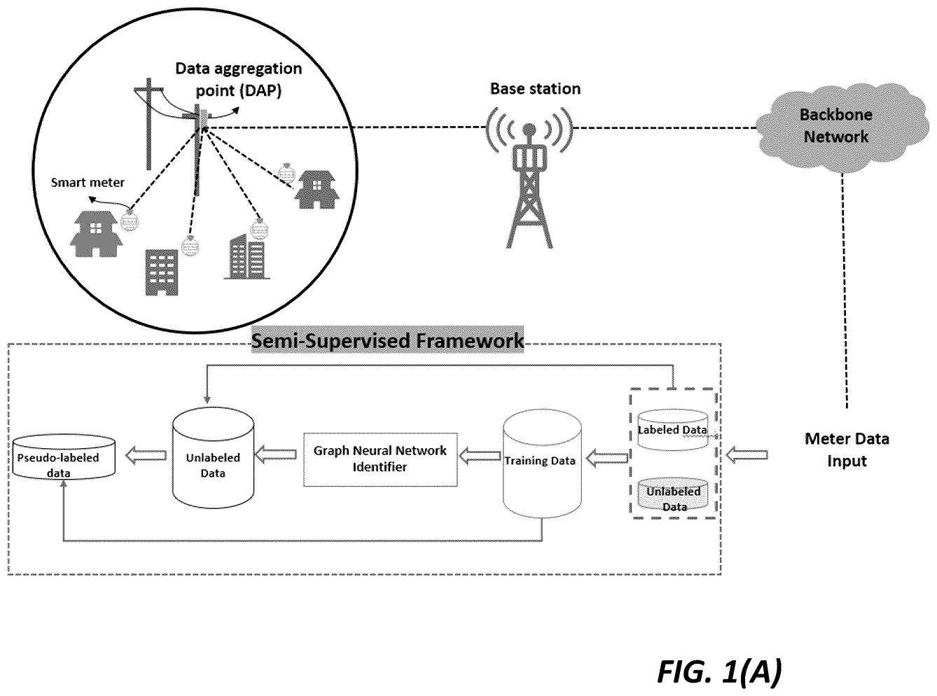

FIG. 1 is a schematic diagrams showing an illustrative GNN based AMI event classification arrangement according to aspects of the present disclosure.

As we shall now show and describe systems and methods according to the present disclosure provide several inventive features.

### Inventive Features Graph Representation of AMI Data

The use of graph neural networks (GNNs) for event classification in AMI data is a new and innovative approach that has not been explored in the state of the art. As those skilled in the art will understand and appreciate however, GNNs are a type of deep learning algorithm that can operate on data represented as graphs, and they are particularly well-suited to modeling the interdependencies and relationships between different devices, meters, and energy consumption patterns in AMI data. One particularly distinguishing aspect of our inventive approach is that we leverage unique features of AMI data, which can be naturally represented as a graph, and use GNNs to capture complex dependencies and interactions between different devices and meters. This allows us to take a holistic approach to event classification in AMI data, rather than treating each device or meter as an independent entity.

A semi-Supervised Learning Framework

We show and describe a Semi-supervised learning framework, where the model is trained on a combination of labeled and unlabeled data. As we have noted, in the case of event classification in AMI, the availability of labeled data is often limited due to the high cost and effort required for manual labeling. As a result, using semi-supervised learning to leverage both labeled and unlabeled data can greatly improve the efficiency and accuracy of event classification.

By incorporating unlabeled data into the training process, the model can learn more robust representations of the underlying structure and patterns in the data, which can help improve the accuracy of event classification. This is especially important in the case of AMI data, where the patterns and relationships between devices and energy consumption can be complex and difficult to capture with traditional supervised learning approaches.

Furthermore, the use of a semi-supervised learning framework in combination with graph neural networks is particularly innovative, as it allows for the efficient and accurate modeling of the interdependencies and relationships between devices and energy consumption patterns. This can lead to more accurate and effective event classification, which is critical for identifying and addressing potential issues such as meter tampering, equipment malfunction, and abnormal energy consumption patterns.

### Novel Graph-Based Feature Selection Method

Compared to previous machine learning-based methods that use only data features as model input, our inventive event identifier combines data features and an interaction graph. To achieve that, a node-to-edge operation is performed on the extracted edge feature. Then, an obtained graph structure is combined with edge features using element-wise multiplication. A 2-dimensional Convolutional Neural Network (CNN) is also implemented to extract additional data features combining with interaction graph, which provides event identifier with sufficient information.

The graph-based feature selection method allows us to identify features that are not only highly correlated with the target label, but also play an important role in the connectivity of the graph. This ensures that the selected features capture not only the statistical relationship between the features and the target label, but also the underlying structure of the AMI data. Overall, our novel feature selection method helps to improve the efficiency and accuracy of the GNN by reducing the dimensionality of the input data while retaining the most informative features for event classification. This is particularly important for AMI data, which often contains many features and can be computationally expensive to process.

### Adaptable to Different Types of Events and Can be Customized to Specific Use Cases

Adaptability and customization are novel aspects of our systems and methods according to aspects of the present disclosure because they allow tailoring to different types of event and use cases. In the context of event classification in AMI, there may be different types of events that need to be detected and classified, such as meter tampering, equipment malfunction, or abnormal energy consumption patterns. Each of these events may have different characteristics and require different approaches for detection and classification.

By using a graph neural network-based approach that incorporates a new feature selection method and a semi-supervised learning framework, our systems and methods according to the present disclosure are customizable to different types of events and specific use cases. This means that the system can be adapted to different data sets and situations, allowing it to be applied to a wide range of scenarios and contexts.

Those skilled in the art will understand and appreciate that such adaptability and customization are critical for the widespread adoption and use of system and methods according to the present disclosure, as it ensures that such systems and methods can be tailored to meet the specific needs and requirements of different organizations, utilities, and end-users. It also means that the systems and methods according to the present disclosure can advantageously continue to evolve and improve over time, as new data sets and use cases emerge.

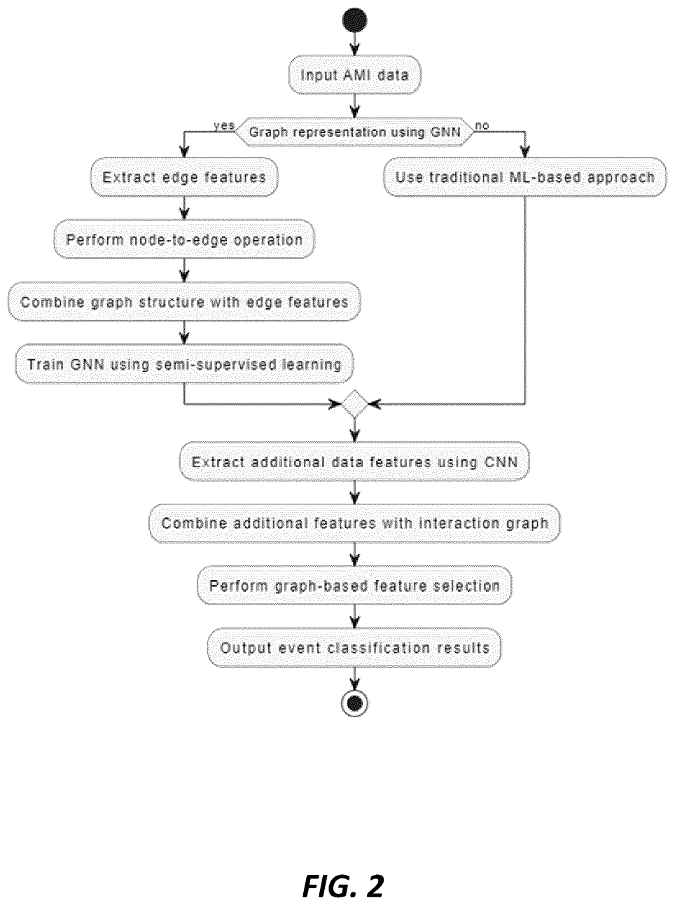

FIG. 2 is a schematic flow diagram showing illustrative features of GNN based AMI event classification systems and methods according to aspects of the present disclosure

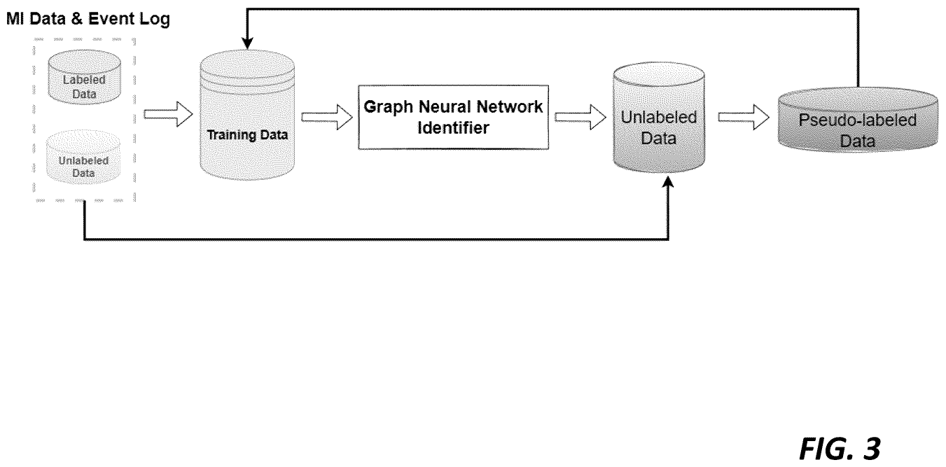

FIG. 3 is a schematic block diagram showing an illustrative semi-supervised framework of a GNN based AMI event classification according to aspects of the present disclosure.

We now describe the steps of GNN based AMI event classifier in semi-supervised learning manner according to aspects of the present disclosure.

Given the prevalence of unlabeled data, the data resources required to train an event classification model inlcude both unlabeled data and a limited amount of labeled data. As shown in FIG. 3, the our inventive framework includes a graph neural network based event identification module. The unlabeled events data can be predicted by graph neural network and assigned a pesudo label, then added to the training dataset if the result id confident. The loss function is standard softmax cross-entropy may be represented by.

$$loss = - \frac{1}{n} {\sum }_{x} [ y ln \hat{y} + ( 1 - y ) ln ( 1 - \hat{y} )$$

Where n is the number of sample, x represents input data. y is true label, ŷ is predicted label.

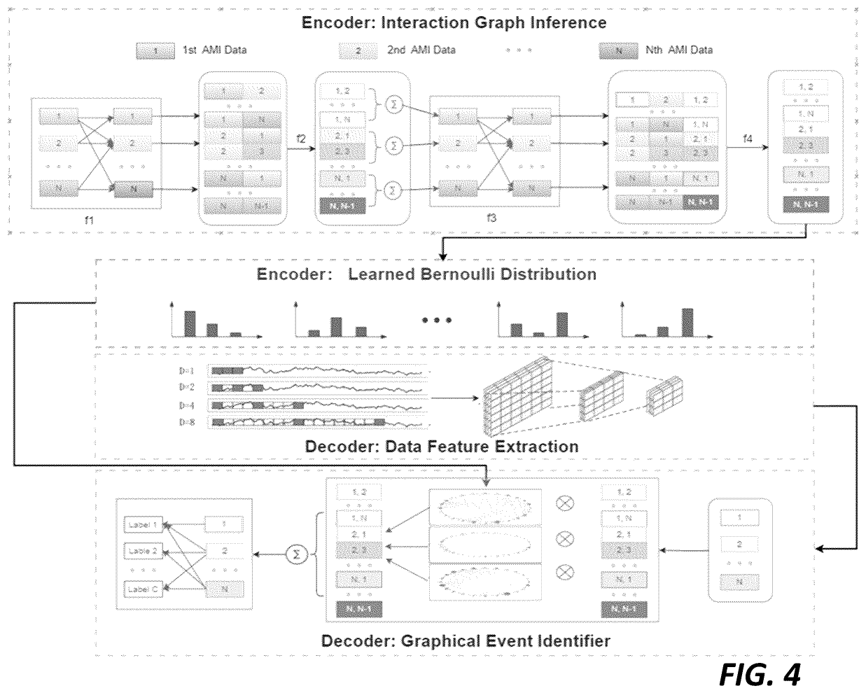

FIG. 4 is a schematic diagram showing an illustrative graph neural network identifier components according to aspects of the present disclosure.

As illustrated in FIG. 4, the spatial-based graph neural network identifier combines with autoencoder to perform interaction learning and event classification. The encoder adopts spatial-based GNNs that act on the fully connected graph with multiple rounds of message passing and infer the potential interaction distribution based on all AMI measurements.

The decoder uses another spatial-based GNN to identify event types based on AMI features and constructed graphs jointly in an unsupervised way. Unlike previous methods that focus on data prediction, the proposed method is capable of extracting multi-scale event features and performing accurate power system event classification. Moreover, since the interactions among different AMIs are impacted by the event location, our approach produces one graph structure for each event rather than a single statistics-based graph.

In our method, each AMI and the corresponding data (i.e., voltage magnitude value) can be considered as a node and an initial node feature. Initial node features consist of {V, L}, where V:={ν₁, . . . νₕ} is the voltage magnitude set from AMI, L:={l₁, . . . , Iₕ} is the corresponding event label set from the event logs, and h is the total number of events.

The goal of the encoder is to compute the latent relationship E_{i,j}:={e_{i,j}¹ . . . , e_{i,j}^{N}}, where e_{i,j} represents the represents the probability of edge existence between AMI i and j. We also use deep neural relational inference to pass local information

$$\begin{matrix}{e}_{i , j}^{k} = {f}_{e}^{k} ( [ {e}_{i}^{k} , {e}_{j}^{k} , {x}_{( i , j )} ] ) \\ {e}_{i}^{k + 1} = {f}_{n}^{k} ( [ {\sum }_{i ∈ {N}_{j}} {e}_{i , j}^{k} , {x}_{j} ] )\end{matrix}$$

where, eᵢ^{k} is the feature of node i in layer k, e_{i,j}^{k} is the feature of edge connecting nodes i and j. Nⱼ is the set of edges connecting nodej. xᵢ and x_{(i,j)} summarize initial nodes and edge features, respectively, and [·,·] denotes the concatenation operation. The functions ƒₑ and ƒₙ refer to node and edge-specific neural network. The ƒₑ is mapped to compute edge updates. The ƒₙ is utilized to compute per-node updates across all nodes. Σ_{i∈N}_{ⱼ}e_{i,j}^{k} is obtained by aggregation of edge features from edges that are connected to node i. The encoder includes the following four steps to infer E_{i,j}:

$$\begin{matrix}{e}_{i}^{1} = {f}_{1} ( {v}_{i} ) \\ Node \to Edge : {e}_{i , j}^{1} = {f}_{e}^{1} ( [ {e}_{i}^{1} , {e}_{j}^{1} ] ) \\ Edge \to Node : {e}_{i}^{2} = {f}_{n}^{1} ( {\sum }_{i \neq j} {e}_{( i , j )}^{1} ) \\ Node \to Edge : {e}_{i , j}^{2} ( [ {e}_{i}^{2} , {e}_{j}^{2} ] )\end{matrix}$$

And two-layer fully connected neuron networks are utilized to model node- and edge-specific neural networks, which can be formulated as follows:

$${f}_{1} ( {v}_{i} ) = a ( {w}_{{f}_{1} , 0}^{( 2 )} + {\sum }_{i = 1}^{N} {w}_{{f}_{1} , i}^{( 2 )} \cdot ( a ( {w}_{{f}_{1} , 0}^{( 1 )} + {\sum }_{n = 1}^{N} {w}_{{f}_{1} , n}^{( 1 )} \cdot {v}_{n} ) ) )$$

Where, w_{ƒ}_{₁}_{,0}, w_{ƒ}_{₁}_{,1}, w_{ƒ}_{₁}_{,2} represent internal weights of ƒ₁ and the exponential linear unit is used as the activation function α in these networks.

Using E_{i,j} the interaction graph is obtained via a graph sampling technique. Here, we apply the following deterministic thresholding method:

$${w}_{i , j} = \{ \begin{matrix}1 if sigmod ( {e}_{i , j} ) > r \\ 0 otherwise\end{matrix}$$

Where, r is a user-defined threshold. The deterministic thresholding method encourages sparsity if r gets closer to 1.

The goal of the decoder is to construct a mapping relationship between AMI data and event types. The basic idea is to fit a boundary in a high-dimensional space to separate data samples with different event types. To achieve superior classification performance in terms of both accuracy and efficiency, it is imperative to implement a convolutional neural network to extract AMI information. When AMI features are obtained. Graph Neural Network is utilized to perform the event classification task. Compared to previous machine learning-based methods that use only data features as model input, our event identifier combines data features and interaction graph. To achieve that, a node-to-edge operation is performed on the extracted edge feature. Then, the obtained graph structure is combined with edge features using the element-wise multiplication. The process can be formulated as follows:

$${h}_{i , t} = {\sum }_{i \neq j} {\sum }_{k = 1}^{K} {w}_{i , j} \cdot {g}_{1} ( [ {u}_{i , t} , {u}_{j , t} ] )$$

Like the encoder, the node-based function g₁ is represented by a two-layer fully connected network that includes rectified linear units as the activation function, which can be formulated as follows:

$${g}_{1} ( [ {u}_{i , t} , {u}_{j , t} ] ) = max ( 0 , {w}_{{g}_{1} , 0}^{( 2 )} + {\sum }_{i = 1}^{N} {w}_{{g}_{1} , 0}^{( 2 )} \cdot max ( 0 , {w}_{{g}_{1} , 0}^{( 1 )} + {\sum }_{i = 1}^{N} {w}_{{g}_{1} , n}^{( 2 )} \cdot [ {u}_{i , t} , {u}_{j , t} ] ) )$$

The event classifier is achieved by adding a two-layer fully connected network after vectorization, as follows:

$$\hat{{l}_{ι}} = {g}_{2} ( [ vec ( {U}_{i} ) , v e c ( {H}_{i} ) ] )$$

where, Hᵢ=[h_{i,1}, . . . , h_{i,T}]. In this fully connected network, the softmax activation function is applied to normalize the output to a probability distribution over estimated event types:

$${g}_{2} ( [ v e c ( {U}_{i} ) , v e c ( {H}_{i} ) ] ) = softmax ( {w}_{{g}_{2} , 0}^{( 2 )} + {\sum }_{i = 1}^{N} {w}_{{g}_{2} , i}^{( 2 )} \cdot max ( 0 , {w}_{{g}_{2} , 0}^{( 2 )} + {\sum }_{n = 1}^{N} {w}_{{g}_{2} , n}^{( 1 )} \cdot [ vec ( {U}_{i} ) , vec ( {H}_{i} ) ] ) )$$

At this point, while we have presented this disclosure using some specific examples, those skilled in the art will recognize that our teachings are not so limited. Accordingly, this disclosure should be only limited by the scope of the claims attached hereto.

1. An event classification method for advanced metering infrastructure (AMI) comprising:
collecting, in a semi-supervised framework, AMI meter data from a plurality of electrical meters;
applying the collected AMI meter data to a Graph Neural Network (GNN), wherein the AMI meter data is represented as a graph;
capturing, by the GNN using the AMI meter data represented as a graph, relationships and dependencies between different electrical meters of the plurality of electrical meters and determining classifying events from the relationships and dependencies; and
providing, to utility and energy providers, the classifying events so determined.

2. The method of claim 1 wherein each electrical meter of the plurality of electrical meters is represented as a node in the graph.

3. The method of claim 2 wherein AMI data used by the GNN is both labeled data and unlabeled data.

4. The method of claim 3 wherein the event classification is performed using a feature selection operation that only uses the most informative features.

5. The method of claim 4 wherein the event classification in the AMI data is performed holistically such that the GNN captures complex dependencies and interactions between different devices and meters, rather than treating each device and meter as an independent entity.

6. The method of claim 5 wherein the GNN is trained using both labeled and unlabeled data.

7. The method of claim 6 in which a convolutional neural network (CNN) is implemented to extract additional data features combining with an interaction graph.
